(19) United States
(12) Patent Application Publication
(10) Pub. No.: US 2014/0305773 A1
(43) Pub. Date: Oct. 16, 2014

(54) SLIP CLUTCH AND ROLLER CONVEYOR INCORPORATING SAME

(71) Applicant: Charles Agnoff, Wilmington, NC (US)

(72) Inventor: Charles Agnoff, Wilmington, NC (US)

(21) Appl. No.: 13/863,706

(22) Filed: Apr. 16, 2013

(51) Int. Cl. B65G 13/071; B65G 23/26

(52) U.S. Cl. CPC B65G 13/071; B65G 23/26
USPC 198/788; 198/805

(57) ABSTRACT

A slip clutch assembly mountable on the end of a rotatable shaft, such as a roller conveyor roller shaft is described. The assembly includes a pulley rotatable around the shaft, the pulley having a circular peripheral wall to receive a conveyor belt, and a central wall with parallel front and rear faces, the wall including a plurality of through holes of a first given diameter and a plurality of magnet recesses of a greater given diameter axially aligned with the through holes and extending partially through the wall from the rear face of the wall; a plurality of magnets positioned in the magnet recesses and spaced from the wall front face, a steel disc attachable to the end of the shaft and attracted into engagement with the outer face of the pulley by the magnets whereby rotation of the pulley rotates the shaft, unless a predetermined load is exceeded.

This application claims the benefit of and priority to the filing date of U.S. Provisional Application Ser. No. 61/647,690, filed May 16, 2012, the entire content of which is incorporated herein.

### BACKGROUND OF THE INVENTION

1. Field of the Invention

The present invention relates generally to magnetic slip clutches, and in particular to roller conveyors having roller shafts incorporating slip clutches to disengage the roller drive mechanism from the roller when a predetermined roller resistance occurs.

2. Description of the Prior Art

Roller conveyors used to convey articles along a given pathway are generally comprised of plurality of spaced, parallel rollers positioned along and transverse to the pathway. A frame having parallel roller support sections supports the rollers. Each roller has a shaft that is supported at its opposed ends by the frame support sections. A portion of each shaft between the support sections includes a roller body that is used to support the article being conveyed.

A conveyor roller may be a driven the roller, i.e., the roller is rotated by a connected drive means, or an idler the roller, i.e., the roller is rotated only by the movement of the article across the roller surface. Generally, a plurality of driven rollers are rotated by a single drive means comprised of a rotational power source connected to the plurality of driven rollers either directly or indirectly, by drive connectors, such as belts or chains extending around pulleys or sprockets on the roller shafts. As used herein the term “drive means” is understood to include the power source and the drive connectors.

The conveyor frame includes a pair of spaced, parallel side rails each having a vertical wall with an inner face, an outer face, and spaced shaft-receiving openings mirroring the opening in the other side rail. The side rails may also be configured to further isolate the drive means from the rollers, e.g., with an upper wall extending outwardly from the upper edge of the vertical wall.

Each driven roller is comprised of a shaft that extends through corresponding openings in the side walls. The shaft may be a continuous shaft extending from through the roller, or a discontinuous shaft comprised of a pair of stub shafts, each stub shaft extending from a sober end. As used herein, the term “shaft” is intended to encompass both continuous and discontinuous shafts. Different roller bodies can be fitted around the shafts.

The shaft, and thereby the roller, is rotated by connecting the shaft to the drive means. In the present invention, a pulley is frictionally attached to the end of the drive shaft, with a belt connecting the pulley directly to a corresponding pulley on a drive motor or to the pulley on another shaft that is attached to the drive motor.

Rotation of the pulley in turn rotates the drive shaft. However, when there is resistance of the roller to rotation beyond a predetermined value, it is desirable for the pulley to slip relative to the shaft, so that damage to the pulley or roller will not result, or it will not be necessary to deactivate the drive means. Resistance to rotation can result from a number of causes.

For example, there may be blockage of the roller rotation, e.g., due to something falling between the roller and an adjacent roller. Also, the movement of articles carried on roller conveyors, known as accumulating conveyors, are often stopped with each article prevented from forward movement due to blockage of the article in front.

Accumulating live conveyors are generally well known to those skilled in the art. In general, a live conveyor is defined as a conveyor having a driving unit for propelling an endless conveying means which, through frictional contact with either a plurality of load-carrying rollers or with a load, transports the load from an upstream end to a downstream end of the conveyor without the assistance of gravity. An accumulating live conveyor includes means for disengaging the endless conveying means from the load-carrying rollers or load in selected areas of the conveyor to stop movement of the load on the load-carrying rollers without stopping or interfering with the operation of the driving unit or endless conveying means. With an accumulating live conveyor, a quantity of loads can be accumulated in a selected area of the conveyor before being moved further downstream or before being removed from the conveyor. Accumulated loads are typically butted-up against each other to form a continuous line of loads in a selected accumulating area of the conveyor.

Accumulation of stationary articles does not pose a serious problem with gravity conveyors. However, in the case of power conveyors, the articles offer substantial resistance to the movement of the drive means, and potential damage. For this reason, it is the common practice to include a slip clutch or other mechanism so that the pulley can continue to rotate at its normal speed even when rotation of the roller is prevented. Generally, slip clutches include two elements that are frictionally attached when rotating under normal loads, but which will slide or slip relative to each other when a predetermined load is exceeded.

### SUMMARY OF THE INVENTION

The present invention relates to an improved slip clutch, and in particular to an improved slip clutch that can form a part of a roller conveyor mechanism, securing a pulley to a shaft for rotation of the shaft under normal loads, but allowing the pulley to continue to rotate even if the rotation of the roller is obstructed.

Generally, the slip clutch assembly of the present invention is comprised of a pulley having an outer cylindrical periphery adapted to receive a conveyor belt and rotatable on the cylindrical end of a shaft, a steel disc attachable to the end of the shaft, and a plurality of magnets mounted on the pulley and adapted to attract the steel disc into frictional engagement with the pulley, whereby rotation of the pulley rotates the shaft, unless a predetermined load is exceeded.

More specifically, the pulley has a circular wall rotatable around a central axis. The outer face of the wall is adapted to receive one or more belts. In the preferred embodiment, the outer surface has ribs to receive a grooved belt. The pulley also includes a circular central wall with parallel front and rear faces, and an axially aligned center bore. The central wall is sized to extend across the area within the circular wall. The central wall rear face includes a plurality of recesses to receive the magnets. Preferably, the magnets are arrayed in a circle and are equally spaced around the central wall.

The central wall also includes bores aligned with the magnets so that each magnet is positioned behind a bore. The diameters of the bores are smaller than the diameters of the magnets. The magnet receiving recesses extend only partially through the central wall so that the magnets are spaced inwardly from the front face of the central wall. As a result, there is a small space or gap between the outer faces of the magnets and the outer face of the central wall. The pulley assembly can also include a retainer to secure the magnets onto the central wall rear face.

The pulley also includes a rearwardly extending stem with an axial cylindrical bore sized to receive the cylindrical outer end of the shaft so that the pulley stem is rotatable about the shaft. The pulley is also slidable onto and off of the end of the shaft.

The steel disc has a circular cross-section with a diameter approximately equal to or slightly less than the diameter of the central wall so that the disc inner face can fit against the central wall outer face. The disc is affixed to the end of the shaft, e.g., by a bolt that extends through the center of the disc and into the end of the shaft. Alternately, the disc may be loosely affixed by keys that engage keyways in the shaft. The clutch assembly is mounted on the frame with a ball-bearing bracket that extends around the pulley stem between the pulley and the frame.

The drive means includes an electric motor with a motor pulley attached to the motor dove shaft. Different drive means configurations may be used. For example, the drive means may be comprised of a gear motor that includes a set of speed reduction gears.

At least one continuous belt is fitted around the motor pulley and a driven roller shaft pulley, whereby rotation of the motor shaft rotates the shaft pulley. The motor pulley and shaft pulley may be of the same or different diameters. The motor can be attached with a single belt to a single shaft pulley, or to two shaft pulleys by fitting a first belt around the motor pulley and the pulley on a first roller, and a second belt around the motor pulley and the pulley on a second roller. Rotation of the motor shaft then rotates the two roller shafts.

Each roller shaft may also be connected to another roller shaft by another belt, i.e., a first shaft pulley connected by a belt to the motor pulley can also be joined by a second belt to the shaft pulley of a second roller. Rotation of the motor shaft then rotates the first shaft and indirectly the second shaft.

In operation, the pulley assembly is slid onto the end of a roller shaft and a belt is placed around the pulley. The inner face of the steel disc is held against the outer face of the central wall by the attraction of the magnets. There is a small gap between the magnets and the steel disc inner face.

When the pulley is rotated by the drive means, the frictional engagement between the pulley central wall and the disc also causes the shaft to rotate with the pulley. However, when rotation of the shaft is obstructed so that the resistance to rotation is greater than the magnetic force holding the disc and central wall in engagement, the pulley will continue to rotate while the shaft remains stationary.

It will be understood that the force required to disengage the disc and central wall will depend on several design features, such as the strength of the magnets, the separation distance of the magnets from the disc, the disc composition, etc.

### BRIEF DESCRIPTION OF THE DRAWINGS

FIG. 1 is a sectional side view of the magnetic clutch assembly.

FIG. 2 is a front view of the magnetic clutch assembly with disc and bolt not shown.

FIG. 3 is a rear view of the magnetic clutch assembly with magnet retainer and spacer not shown.

FIG. 4 is a front view of the disc.

FIG. 5 is a side view of a conveyor including drive and driven rolls incorporating the magnetic clutch assembly.

FIG. 6 is a sectional end view of a driven roller.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

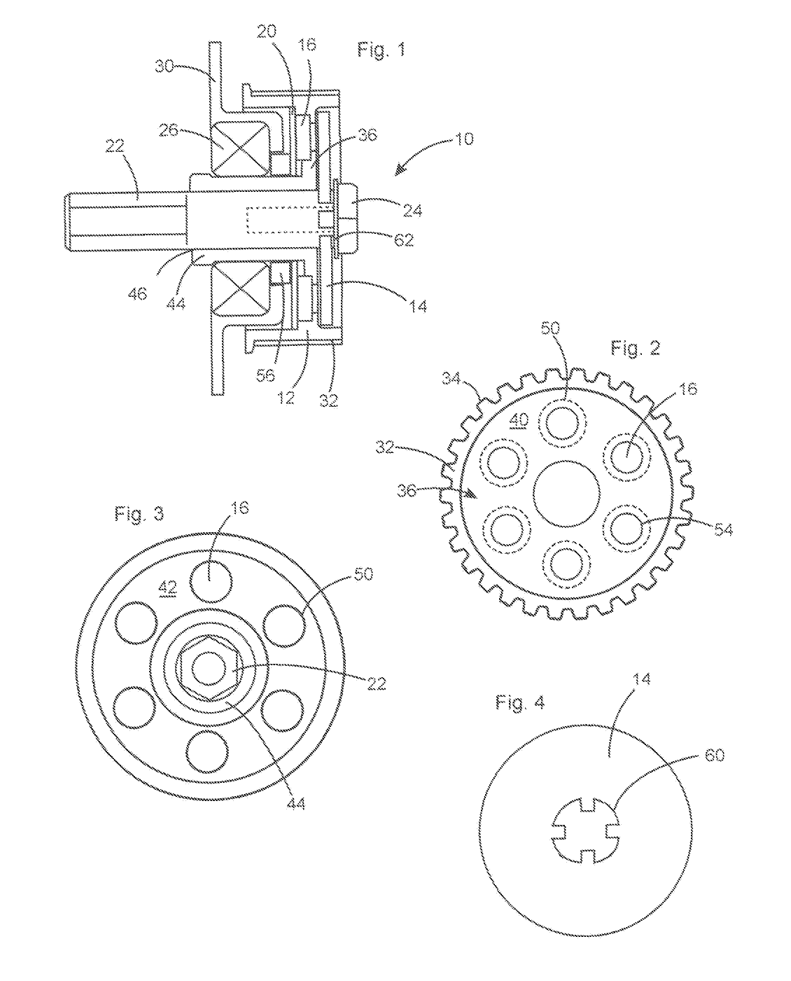

As best shown in FIGS. 1-4, the magnetic clutch assembly, generally 10, is comprised of a pulley 12, a steel disc 14, a plurality of magnets 16, and a magnet retainer plate 20. Assembly 10 is mounted on stub shaft 22 with bolt 24. A donut-shaped bearing 26 is positioned between assembly 10 and conveyor frame mount 30.

Pulley 12 includes a continuous circular wall 32 with a ribbed outer face 34, and a transverse central wall 36 extending across pulley 12 inside wall 32. Central wall 36 has parallel front and rear faces, 40 and 42. Shaft stem 44 extends rearwardly from rear face 42 and includes an axial shaft bore 46 that extends through wall 36.

Central wall 36 also includes a plurality of recesses 50 in rear face 42 to receive a plurality of circular magnets 16. A plurality of holes 54 aligned with recesses 50 extend from recess 50 to front face 40. The diameters of holes 54 are smaller than the diameters of magnets 16. Magnets 16 are spaced rearwardly from front face 40, so that there are spaces or gaps between magnets 52 and the plane of face 40. Retainer plate 20 holds magnets 16 in recesses 50. Spacer 56 is positioned between plate 20 and bearing 26.

Steel disc 14 includes a central attachment opening 60 for insertion of bolt 24 to attaching assembly 10 to stub shaft 22. A washer 62 is positioned between disc 14 and the head of bolt 24. Disc 14 is circular with a diameter approximately the same as the diameter of central wall 36 so that disc 14 can be inserted inside wall 32.

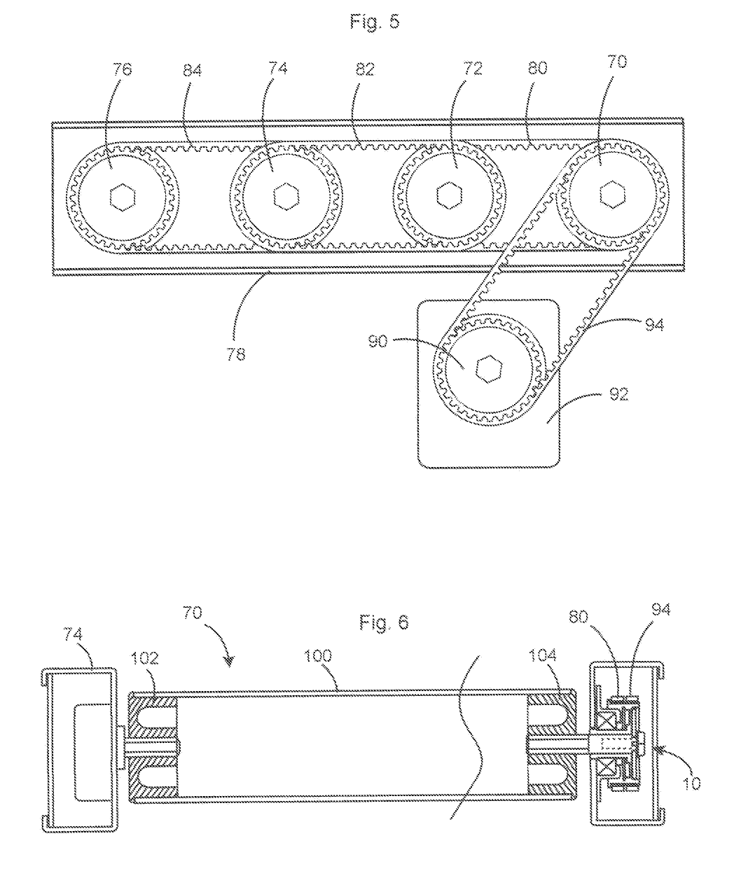

As shown in FIG. 5, driven rollers 70, 72, 74 and 76 are mounted parallel to each other on conveyor frame 78. The rollers are connected by belts 80, 82 and 84, which are preferably ribbed belts. Roller 70 is attached to pulley 90 on the shaft of gear motor 92 by belt 94. Since the driven rollers are all connected by belts, it will be understood that gear motor 92 can be connected to either of the driven rollers. It will also be understood that more of fewer rollers can be joined together.

As illustrated, belt 80 around pulley 12 on rollers 70 rotate the pulley attached to driven roller 72. Since roller 72 is connected to roller 74 by belt 82, and roller 74 is connected to roller 76 by belt 84, rotation of pulley 12 on roller 70 rotates corresponding pulleys on all of the rollers.

Roller 70, illustrated in FIG. 6, is constructed of roller tube 100 and end caps 102 and 104. Cap 102 is freely rotatable, while cap 104 has a central hex bore to receive stub shaft 22 extending from assembly 10, so that roller 72 rotates upon rotation of pulley 12. Rollers 72, 74 and 76 have like constructions.

If a predetermined load on either roller is exceeded, its respective pulley will continue to rotate, while the rotation of the affected roller will stop since the magnetic force will no longer be sufficient to hold disc 14 in engagement with the outer face of central wall 36.

Certain modifications and improvements will occur to those skilled in the art upon a reading of the foregoing description. While the magnetic assembly has been described with specific reference to conveyor rollers, the magnetic assembly will also find application in numerous other applications where it is desirable to permit continuous operation of a drive means when an associated shaft is prevented from rotation. It should be understood that all such modifications and improvements have been deleted herein for the sake of conciseness and readability but are properly within the scope of the following claims.

What is claimed is:

1. A slip clutch assembly mountable on a cylindrical outer end of a rotatable shaft, said assembly comprising:
a) a pulley insertable onto and rotatable around said shaft, said pulley having a circular wall adapted to receive a conveyor belt, and a central wall with parallel from and rear faces;
b) a plurality of magnets positioned on said central wall rear face;
c) a steel disc attachable to the end of said shaft, said disc being attracted into engagement with outer face of said pulley by said magnets whereby rotation of said pulley rotates said shaft, unless a predetermined load is exceeded.

2. The slip clutch assembly of claim 1, wherein said central wall rear face includes a plurality of recesses having a depth less than the thickness of said wall, said magnets being secured within said recesses and spaced inwardly from said central wall front face.

3. The slip clutch assembly of claim 1, wherein said central wall includes a plurality of through holes, said magnets being mounted over said holes.

4. The slip clutch assembly of claim 1, wherein said circular wall is ribbed.

5. The slip clutch assembly of claim 1, wherein said magnets are arrayed in a circle and are equally spaced around said central wall rear face.

6. The slip clutch assembly of claim 1, further including a retainer to secure said magnets to said central wall rear face.

7. The slip clutch assembly of claim 1, wherein said pulley includes a rearwardly extending stem with an axial cylindrical bore sized to receive said shaft end so that said pulley is rotatable about said shaft end.

8. A slip clutch assembly mountable on a cylindrical outer end of a shaft of a roller conveyor roller, aid assembly comprising:
a) a pulley inserted onto and rotatable around said shaft, said pulley having a circular wall adapted to receive a conveyor belt, and a circular central wall with parallel front and rear faces, said wall including a plurality of through holes of a first given diameter extending between said front and rear faces, and a plurality of magnet recesses of a second given diameter axially aligned with said through holes and extending partially through said wall from the rear face of said wall, said second given diameter being greater than said first given diameter;
b) a plurality of magnets positioned in said magnet recesses, said magnets having diameters greater than said first given diameter, said magnets being spaced from said wall front face;
c) a steel disc attachable to the end of said shaft, said disc being attracted into engagement with the outer face of said pulley by said magnets whereby rotation of said pulley rotates said shaft, unless a predetermined load is exceeded.

9. The slip clutch assembly of claim 8, wherein said pulley circular wall is ribbed and said conveyor belt is grooved.

10. The slip clutch assembly of claim 8, wherein said magnets are arrayed in a circle and are equally spaced around said clutch pulley central wall rear face.

11. The conveyor of claim 8, further including a retainer to secure said magnets to said central wall rear face.

12. The conveyor of claim 8, wherein said pulley includes a rearwardly extending stem with an axial cylindrical bore sized to receive said shaft end so that said clutch pulley is rotatable about said shaft end.

13. A roller conveyor comprised of:
a) a frame;
b) at least one driven roller having a first shaft end;
c) a rotary drive means including a rotatable drive pulley;
d) a clutch pulley inserted onto and rotatable around said shaft, said pulley having a circular wall adapted to receive a conveyor belt, and a circular central wall with parallel front and rear faces;
e) a plurality of magnets positioned on said central wall rear face;
f) a steel disc attachable to the end of said shaft, said disc being attracted into engagement with the outer face of said pulley by said magnets whereby rotation of said pulley rotates said shaft, unless a predetermined load is exceeded; and
g) a conveyor belt extending around said clutch pulley and said drive pulley.

14. The roller conveyor of claim 13, wherein said drive means is an electric motor having a shaft operably connected to said drive pulley.

15. The conveyor of claim 13, wherein said clutch pulley central wall rear face includes a plurality of recesses having a depth less than the thickness of said wall, said magnets being secured within said recesses and spaced inwardly from said central wall front face.

16. The conveyor of claim 13, wherein said clutch pulley central wall includes a plurality of through holes, said magnets being mounted over said holes.

17. The conveyor of claim 13, wherein said clutch pulley circular wall is ribbed.

18. The conveyor of claim 13, wherein said magnets are arrayed in a circle and are equally spaced around said clutch pulley central wall rear face.

19. The conveyor of claim 13, further including a retainer to secure said magnets to said central wall rear face.

20. The conveyor of claim 13, wherein said clutch pulley includes a rearwardly extending stem with an axial cylindrical bore sized to receive said shaft end so that said clutch pulley is rotatable about said shaft end.

21. A roller conveyor comprised of:
a) a frame including first and second spaced, parallel side rails, each rail having a vertical wall with inner and outer faces, and shaft-receiving opening mirroring shaft-receiving openings in the other side rail;
b) at least one driven roller having a first shaft end extending through a shaft-receiving opening in the first wall and a second shaft end extending through a shaft-receiving opening in the second side wall;
c) a rotary drive means including a rotatable drive pulley mounted outside said first wall;
d) an electric motor having a shaft operably connected to a drive pulley;
e) a clutch pulley inserted onto and rotatable around said shaft, said pulley having a circular wall adapted to receive a conveyor belt, and a circular central wall with parallel front and rear faces, said wall including a plurality of through holes of a first given diameter extending between said front and rear faces, and a plurality of magnet recesses of a second given diameter axially aligned with said through holes and extending partially through said wall from the rear face of said wall, said second given diameter being greater than said first given diameter;
a plurality of magnets positioned in said magnet recesses, said magnets having diameters greater than said first given diameter, said magnets being spaced from said wall front face;
g) a steel disc attachable to the end of said shaft, said disc being attracted into engagement with the outer face of said pulley by said magnets whereby rotation of said pulley rotates said shaft, unless a predetermined load is exceeded; and
h) a conveyor belt extending around said clutch pulley and said drive pulley.

22. The conveyor of claim 21, wherein said clutch pulley circular wall is ribbed and said conveyor belt is grooved.

23. The conveyor of claim 21, wherein said magnets are arrayed in a circle and are equally spaced around said clutch pulley central wall rear face.

24. The conveyor of claim 21, further including a retainer to secure said magnets to said central wall rear face.

25. The conveyor of claim 21, wherein said clutch pulley includes a rearwardly extending stem with an axial cylindrical bore sized to receive said shaft end so that said clutch pulley is rotatable about said shaft end.
